(19) United States
(12) Patent Application Publication
(10) Pub. No.: US 2014/0100984 A1
(43) Pub. Date: Apr. 10, 2014

(54) METHOD FOR REGULATED MANAGEMENT OF VIRTUAL VISIONS

(71) Applicant: "DUVAMIS" EOOD, Sofia (BG)

(72) Inventor: Dobromir Hristov GOUSHTEROV, Sofia (BG)

(73) Assignee: "DUVAMIS" EOOD, Sofia (BG)

(21) Appl. No.: 13/897,445

(22) Filed: May 20, 2013

(30) Foreign Application Priority Data
Oct. 9, 2012 (BG) 111322

(51) Int. Cl. G06Q 50/00; G06Q 50/18; G06Q 20/12

(52) U.S. Cl. CPC G06Q 50/01; G06Q 20/123; G06Q 50/184
USPC 705/26.3; 709/204; 705/312; 705/39; 705/310

(57) ABSTRACT

The method for regulated management of virtual visions which their creators use to communicate in a multilayered communicative fragmentation positioned in a network environment will be applied mainly, but not only, to platforms for communication between network users such as social networks, astral media, etc. According to the method the users (1) via user devices (2) connect to the computer network (3) and get an opportunity to use the services of the provider (4), set up a user account (5) and access the services (6) of the provider (4). Then the users create one or more virtual visions (8) with the number of virtual visions being unlimited. The creation of a virtual vision (8) is recorded as an entry (9) in the data base (10) supported by the service provider (4). When creating a virtual vision (8) the creator (1) specifies the conditions for objectification of the vision in the services of the provider (4). The creators (1) of virtual visions (8) are free to operate them without limitations by selling them, transferring them, bequeathing them, leaving them as “memory”, etc.

### CROSS-REFERENCE TO RELATED APPLICATIONS

This application claims priority to, and the benefit of, under 35 U.S.C. 119, Bulgarian Patent Application No. 111322, filed on Oct. 9, 2012, the disclosure of which is incorporated herein in its entirety.

### TECHNICAL FIELD

This invention refers to a method for regulated management of virtual visions which their creators use to communicate in a multilayered communicative fragmentation positioned in a network environment to be applied mainly, but not only, to platforms for communication between network users such as social networks, astral media, etc.

### BACKGROUND OF THE INVENTION

There are universally known social networks wherein the users connect via user devices to the computer network, e.g. Internet, in order to be able to communicate with other users through the services provided by the provider upon logging on the provider's home page. To be able to achieve the above the users register their own account and are granted access to the services of the provider. The registered accounts that the users employ to use the services of the provider may only be edited by adding, changing or deleting certain descriptive characterictics as predefined by the provider. These social networks also allow for fully deleting a given registered account, i.e. account and profile in the existing networks is the same thing.

A disadvantage of the existing methods of operating with user accounts is that account management is limited in terms of functional options usually restricted to the user account since the user account is one whole with the user profile. Another disadvantage is that the actions relating to user account management are not time-sensitive, e.g. the objectification of a user account (profile) to take place at a predefined moment in time or time interval (e.g. in the future).

A disadvantage of the existing methods is also that the user account management options are strongly limited as functionalities, mostly to deleting user accounts (profiles).

### SUMMARY OF THE INVENTION

A goal of the invention to design a method having enhanced functional options for regulated management of virtual visions which their creators use for mediated communication in the astral media in a certain period of time.

The goal is achieved by developing a method for regulated management of virtual visions which their creators use for regulated communication among themselves in a network environment. In this case the users of the network connect to the computer-network, e.g. Internet, via user devices. Then the users create their own user accounts and receive access to the services of the provider.

According to the invention upon registration the users create one or more virtual visions associated to the user account with the number of virtual visions being unlimited and users being able to create virtual visions multiple times. A user of the astral media who has created one or more virtual visions becomes a creator. The creation of a virtual vision is registered by an entry in the data base supported by the service provider software.

When a virtual vision is created its creator specifies the conditions under which the virtual vision is to be objectified in the services of the provider. The creators can freely and without limitations manage their virtual visions using all the functionalities offered by the service provider, including to delete them from the provider network.

The objectification of a given virtual vision is subject to a predefined moment in time or time interval.

Another condition for the objectification of a virtual vision may be a predefined condition such as information provided by external parties which the provider may deem useful for its clients.

The creator may operate as s/he sees fit with the virtual visions they created or own. For instance, the creator may indirectly bequeath to another creator in the astral media the virtual visions s/he owns. For this purpose upon logging in the system the creator fills in an e-will wherein s/he specifies the concrete terms of the will. Then the e-will is saved in a data base provided by the provider.

The creator may operate with the created virtual visions by saving them as “memory”. For the purpose s/he connects with a user device via the network environment to the home page of the provider. Upon logging in the account in the provider's system, the creator fills in a “leave as memory” form and sends it to the provider. The system processes the request and indicates to the other creators that the respective virtual vision has been left as “memory”.

The creator may operate with his/her own virtual visions associated with his/her account by selling them. For the purpose the creator via the user device and the network connects to the home page of the provider. Upon logging in the provider's system the creator fills in a sale form which sends to the provider. The system processes the request and sends an indication to that effect to the other creators. The creator who wants to buy the virtual vision using the user device connected to the network goes to the home page of the provider and initiates log in with username and password or any other log in option. Then they browse the section for visualization of the visions for sale and send a purchase request. The system sends a system request to the creator-seller of the virtual vision who connects using his/her user device via the network to the home page of the provider and logs in the system. Once the creator-seller has reviewed and assessed the offers, s/he chooses an offer and the systems provides the creator-buyer with a way to pay for the virtual vision. Upon payment and payment verification the transaction is finalized and the system transfers the purchased virtual vision into the account of the new creator (owner) to navigate it in the provider's services.

One of the possible concrete offers for selling or acquiring virtual visions may be in the form of auctions or visions swap.

Each creator may operate with his/her virtual visions by transferring the usage rights to other user accounts. When a creator wants to transfer the usage rights, s/he connects via the user device to the network and initiates system log in on the home age of the provider. Then the creator fills in a form, provided by the service provider, whereby s/he declares his/her decision to transfer the virtual vision and specifies the duration and other conditions relating to the transfer of usage to other creators. Upon filling in the form the system sends a request to the user account which the transfer is to. The creator being transferred usage rights for the virtual vision for a period of time and/or under other conditions can accept or not accept the transfer offer. For the purpose the creator receiving the transfer offer via the user device connected to the network and via the home page of the service provider initiates system log in. Then the creator fills in a user form whereby s/he declares whether s/he accepts or not the transfer of the virtual vision. If the creator accepts the virtual vision, the system changes the rules of use and if the creator does not accept, the system does not initiate any changes to the associated account.

As mentioned above a given virtual vision may be transferred for a certain period of time and/or until the occurrence of specific, predefined circumstances. For the purpose the service provider system has a module for tasks relating to transfer termination which retrieves information about the timing and/or occurrence of the transfer conditions as well as information about the accounts from the service provider data base. After retrieving the necessary information the module for tasks relating to transfer termination performs checks as to whether the time and/or termination transfer conditions are in place. When the conditions are met, the system returns the virtual vision to the account it was transferred from.

The creator may freely operate with the virtual visions s/he owns, including to delete them but without losing his/her user account. In order to delete a virtual vision from the provider's system, the creator owning the respective virtual vision via the user device connected to the computer network accesses the home page of the provider an logs in the system. Then the creator fills in a virtual vision deletion form whereby the vision is deactivated and/or stops being accessible to all the service users which discontinues the objectification of the vision as well.

The system allows for deferred objectification of a virtual vision in the provider's services subject to certain objectification conditions. For the purpose the creator using the user device connected to the network enters the home page of the service provider and initiates log in. Then the creator fills in a deferred creation and objectification form, and the system registers it in the data base of the service provider.

In order to perform automatic deferred objectification of a virtual vision, the system supports an automatic deferred objectification module. This module connects to and retrieves information from the data base of the service provider and performs checks as to whether the predefined automatic deferred objectification conditions entered into the form are in place. If the conditions are met, the system performs objectification or executes the functionalities entered on behalf of the virtual vision.

An advantage of this invention is that it provides ample functional options for regulated management of virtual visions that their users employ to communicate in the network environment in a specific or not period in time.

### BRIEF DECSRIPTION OF THE DRAWINGS

FIG. 1 shows a block scheme of the users' access to the services of the provider.

FIG. 2 shows a block scheme of the creation of a virtual vision and specification of a conditional moment for its objectification.

FIG. 3 shows the objectification of virtual vision subject to a creator-specified predefined time.

FIG. 4 shows the objectification of virtual vision subject to the occurrence of creator-specified predefined circumstances.

FIG. 5 shows the process of bequeathing a virtual vision.

FIG. 6 shows the process of executing the will.

FIG. 7 shows the process of leaving as “memory” of a virtual vision.

FIG. 8 shows the process of offering a virtual vision “for sale.”

FIG. 9 shows the process of requesting to purchase a virtual vision.

FIG. 10 shows the process of finalizing the virtual vision sale transaction.

FIG. 11 shows the process of “transferring” a virtual vision.

FIG. 12 shows the process of accepting a transferred virtual vision.

FIG. 13 shows the process of verification whether the period of virtual vision transfer has expired and it is to be returned.

FIG. 14 shows the process of deleting a virtual vision.

FIG. 15 shows the process of creating a request for deferred automatic objectification of a virtual vision.

FIG. 16 shows the process of verification if the time for the deferred objectification of virtual vision has come.

FIG. 17 shows the process of creating a request for executing deferred functionalities.

FIG. 18 shows the process of verifying if the time has come for deferred automatic execution of functionalities of a certain virtual vision.

### DETAILED DESCRIPTION OF THE INVENTION

The method of regulated management of virtual visions which the creators use to communicate in a network environment involves:

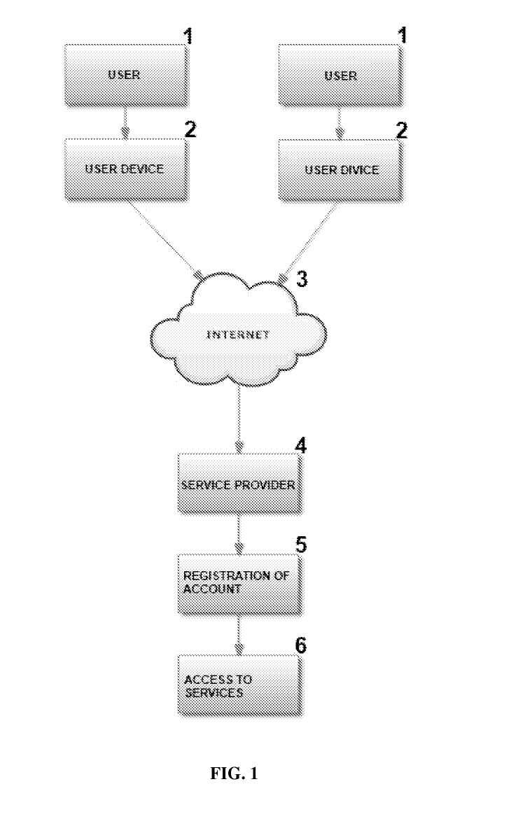

The users 1 via their user devices 2 (tablets, mobile devices, PCs, etc) connect to the network 3 (e.g. Internet)—FIG. 1. After logging in the network 3, the users 1 should create their own account 5 through which to access the services 6 of the provider 4.

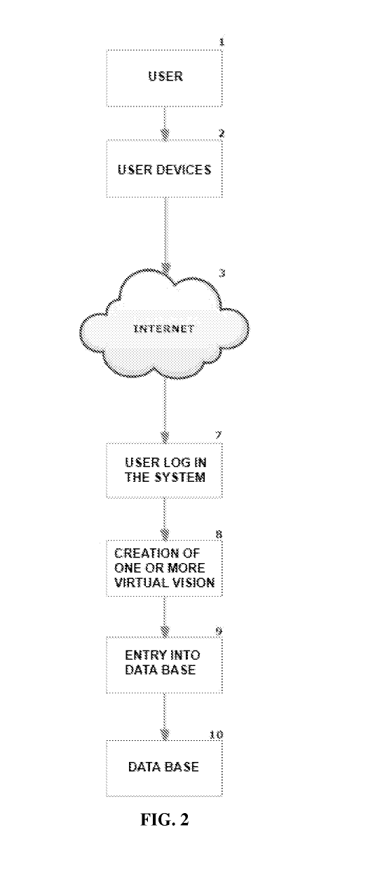

After accessing the services 6 of the provider 4, the users 1 can via their user devices 2 connected to the computer network 3 verify their authorization to use the services of the provider 4 by logging in 7 the system of the provider and creating a virtual vision 8 associated with their user account 5—FIG. 2. Depending on the services of the provider 4 the option to create a virtual vision 8 may be single or multiple. A user of the astral media who has created one or more virtual visions 8 becomes a creator.

The creation of a virtual vision 8 is registered by way of entry 9 in the data base 10, specially supported by the service provider 4. When a virtual vision 8 is created its creator 1 may specify the conditions under which it can be objectified in the services of the provider 4. Such conditions may be, but are not limited to, exact moment in time (exact date and time, week, month, year as well as time interval—e.g. one week after the last user log in the system of the provider 4), conditions based on outside information for the provider 4—e.g. specific currency value, concrete events (concerts and other events, natural disasters, sports results, and others as the provider 4 may deem useful for its users 1).

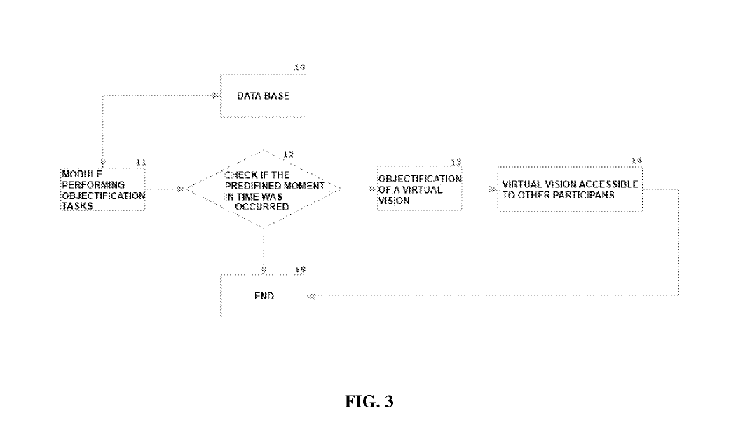

The creator 1 is entitled to freely operate with the virtual visions 8 s/he created and owns. In this way for instance FIG. 3 shows the objectification of a virtual vision 8 subject to a creator-specified 1 predefined time. In order to meet the condition for time objectification of a virtual vision 8 created by creator 1 the provider's 4 system often contains a special module 11 for performing tasks related to objectification of virtual visions 8 in the system of the provider 4 so that it is accessible for some or all creators 1 in the system of the provider 4. In order to support the functionality of this module 11 it is directly connected to the entries 9 in the data base 10. Module 11 performs regular checks 12 as to whether the time defined at the moment of the creation of the virtual vision 8 has come. If no specific time moment as entered into the data base 10 is reached, module 11 does not perform any operations relating to the objectification of virtual visions 8 in the system of the provider 4. If a specific time moment for the objectification of one or more virtual visions 8 is reached, then the system performs operation 13 and provides access 14 to the concrete profiles of the other participants in the services of the provider 4 thus completing the operation of automatic objectification subject to a specified predefined time 15.

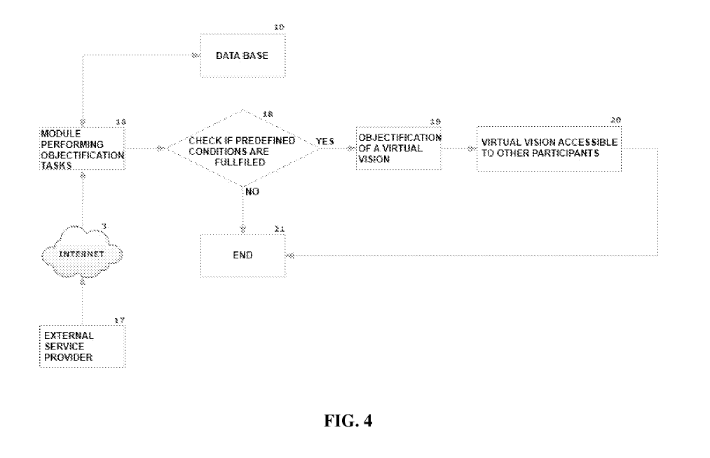

FIG. 4 shows the objectification of virtual vision 8 subject to the occurrence of creator-specified 1 predefined circumstances coordinated with the options offered by the service provider 4. In order for the creator 1 to fulfill the condition for objectifying the created virtual vision 8, there is usually a special module 16 created in the service provider 4 system performing virtual visions 8 objectification tasks in the system of the provider 4 and it is created in such a way so as to be accessible for some or all creators in the provider's 4 system. In order to support the functionality of this module 16, it is directly connected to the entries 9 in the data base 10 as well as it uses a special communication channel via Internet or another network 3 to connect to external information service providers 17. Such services may be, but are not limited to, RSS emissions, other specially formatted emissions (JSON, XML, CSV, etc.), and all other methods as the provider 4 deems suitable. This specific module 16 performs regular checks 18 as to whether the concrete circumstances entered into the data base 10 have occurred. To establish if the concrete circumstances entered into the data base 10 have occurred, the module 16 performs a check 18 by comparing the data in the data base 10 to the data about the concrete circumstance provided by an external service provider 17. The external service provider 17 is external to module 16 and may or may not be part of the services of the provider 4. There may be two possible output statuses resulting from the check 18. The first one is non-fulfillment of the conditions entered into the data base 10 in which case module 16 does not perform any operation relating to the objectification of virtual visions 8. If the conditions entered into the data base 10 are fulfilled, then the virtual vision 8 is objectified 19 in the services of the provider 4 and the system provides access 20 to the virtual vision 8 to the other participants, which completes the objectification operation 21.

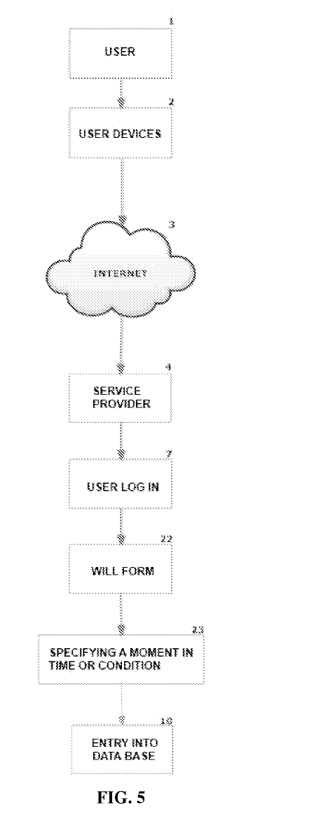

Apart from the objectification of virtual vision 8 upon occurrence of certain circumstances, the system also allows for bequeathing virtual vision/s 8. For the purpose the creator 1 should have created a user account 5 and a virtual vision 8. Via his/her user device 2 the creator 1 connects to the computer network 3 and accesses the system of the service provider 4—FIG. 5. Depending on the service provider 4 s/he should initiate system log in using the registration data 5. Upon successful log in the creator 1 can fill in a special will form 22 specifying the concrete terms of the will 23. The filled form is then saved in a special data base 10 provided by the service provider 4. The service provider 4 also supports a special module performing vision bequeathing tasks 24.

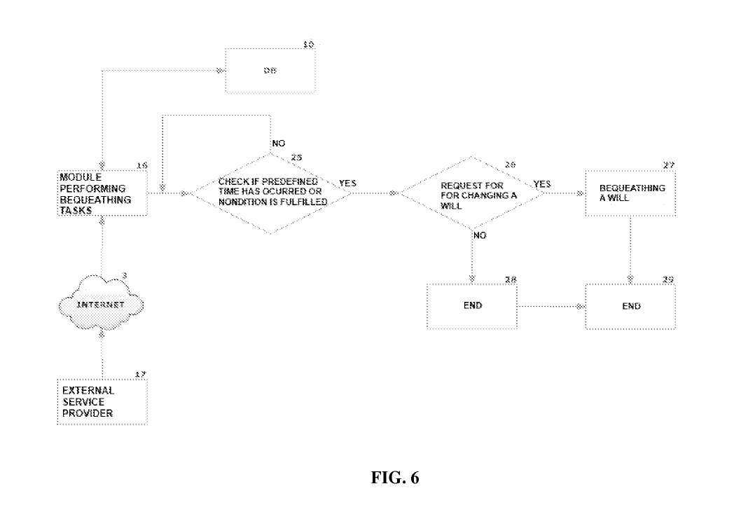

The module performing profiles bequeathing tasks 24 retrieves information about the conditions for bequeathing virtual visions 8 from the data base 10 and compares them depending on the conditions with external service providers 17 via the computer network 3 or with internal services part of module 24—FIG. 6. The services of an external provider 17 are used for instance when the condition specified in the will relates to a certain currency exchange rate, stock values, etc. The internal services of module 24 may be used for instance in the case when the condition specified in the will relates to the occurrence of a certain astronomical time.

In order to support the functionality of this module 24, it is directly connected to the entries 9 in the data base 10 as well as it uses a special communication channel via Internet or another network 3 to connect to external information service providers 17. Such services may be, but are not limited to, RSS emissions, other specially formatted emissions (JSON, XML, CSV, etc.), and all other methods as the provider 4 deems suitable. This specific module 24 performs regular checks 25 as to whether the concrete circumstances entered into the data base 10 have occurred. To establish if the concrete circumstances entered into the data base 10 have occurred, the module 24 performs a check 25 by comparing the data in the data base 10 to the data about the concrete circumstance provided by an external service provider 17. The external service provider 17 is external to module 24 and may or may not be part of the services of the provider 4. There may be two possible output statuses resulting from the check 25. The first one is non-fulfillment of the conditions entered into the data base 10 in which case module 24 does not perform any operation relating to the bequeathing of virtual visions 8. If the conditions entered into the data base 10 are fulfilled, then the system of the service provider 4 send a request for accepting the bequest.

This invention also allows for the so called leaving as “memory” of virtual visions 8 as well as for any other form of virtual communication in a network environment 3. This functionality indicates to the other participants in the services of the provider 4 and not only to them the latent status of the given virtual vision 8. Apart from indicating the latent status in terms of purely information function the provider 4 may use the specific functionality as a precondition for providing other functionalities such as decision-making in a certain communication group can take place based on general (the group members) vote requiring all members to cast their vote. The functionality is inconvenient when the individual person as member of the group has no access to the network 3 for some planned reasons. In order not to block the vote, s/he is given an option to leave as “memory” their virtual vision and thus the services of the provider 4 do not temporarily require his/her vote in the particular decision-making process (voting).

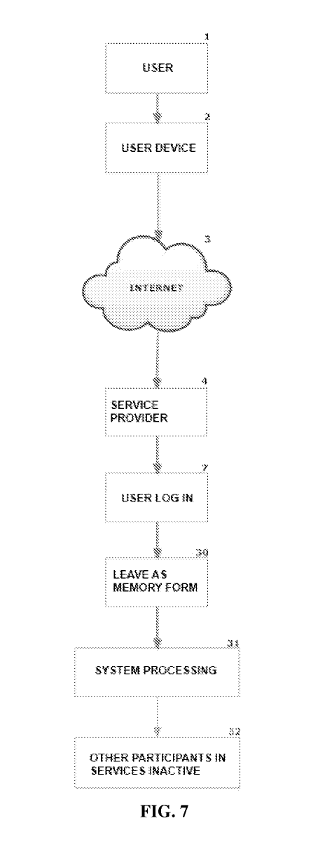

Functionally the leaving as memory takes place in the following manner. Creator 1 via the user device 2 and via the network 3 (e.g. Internet) connects to the home page of the provider 4—FIG. 7. Upon logging in the account 7 in the provider 4 system, the creator 1 can fill in a special form 30 for leaving as “memory”. After form 30 is filled and sent to the provider 4 the system processes request 31 and indicates to the other creators 1 that the respective virtual vision 8 is left as “memory” 32.

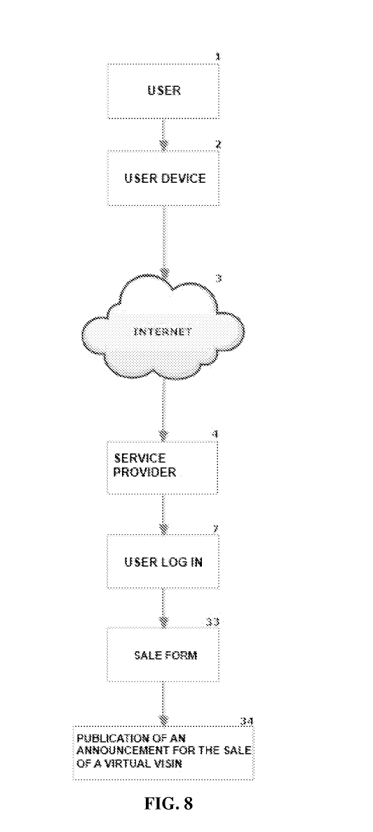

This invention also allows for paid transfer or sale of certain virtual visions 8. Functionally the sale of a virtual vision 8 takes place in the following manner: The creator 1 via the user device 2 and the network 3 (e.g. Internet) connects to the home page of the provider 4—FIG. 8. Upon logging in the account 7 in the system of the provider 4 the creator 1 can fill in a special form 33 for offering a vision for sale. After form 33 is filled and sent to the provider 4 the system processes request 34 and indicates to the other creators 1 that the respective virtual vision 8 is offered for sale. This may take the form of an announcement published in a given section of the system of the service provider 4.

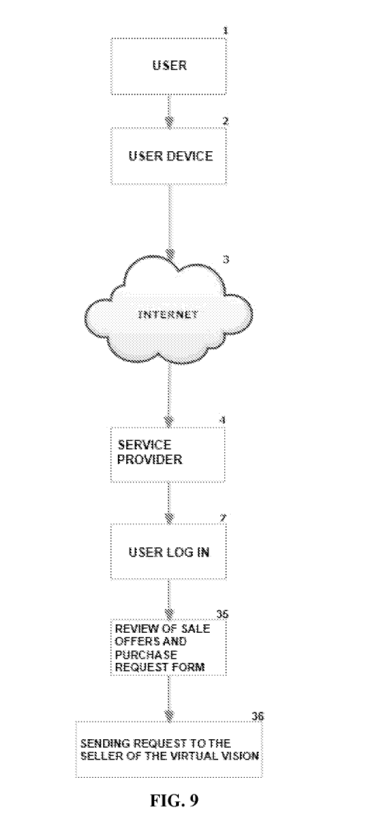

In order for a virtual vision 8 sale transaction to take place, the creator 1 willing to purchase the respective virtual vision 8 should via the user device 2 and via the network 3—e.g. Internet—go to the home page of the provider 4. Upon successful log in the system 7 on the home page of the provider s/he can browse the special section which the service provider 4 has designated for visualization of virtual visions 8 offered for sale—FIG. 9. Along with reviewing the offers s/he is entitled to send a purchase request—7. This request makes it possible to directly purchase or bid for the vision, or to issue any other purchase offer. After form 35 representing the purchase offer is sent, the system sends a system request 36 to creator 1 as the seller of the virtual vision 8.

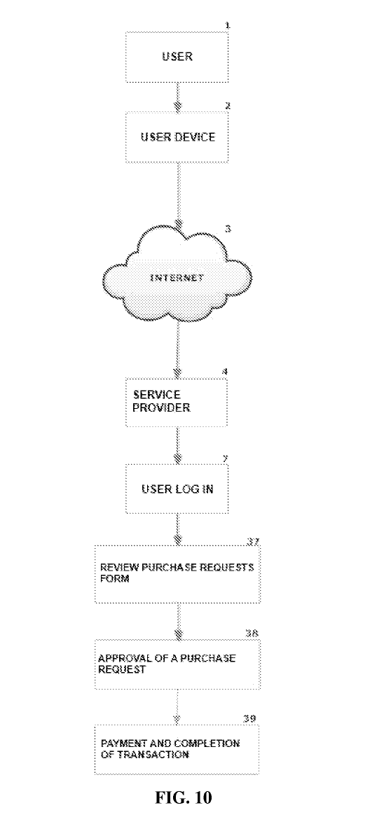

In order to finalize the virtual vision 8 purchase transaction the creator—seller 1 should connect via the user device 2 and via the network 3 to the home page of the service provider 4 and log in 7 the system where the service provider 4 has created a special section 37 showing the offers for purchasing virtual visions 8 for sale—FIG. 10. After reviewing the offers and assessing them the creator—seller 1 should choose a specific form 38 for the acquisition of a virtual vision 8 (it may entail bidding or another format as selected by the service provider 4 such as virtual visions 8 swap) whereby the system provides the creator—buyer 1 with a way to pay for the virtual vision (e.g. via a payment system of the service provider 4 or of another provider of payment services). After the payment is made and verified 39, the transaction is completed and the system transfers the purchased virtual vision 8 to the account of the new creator.

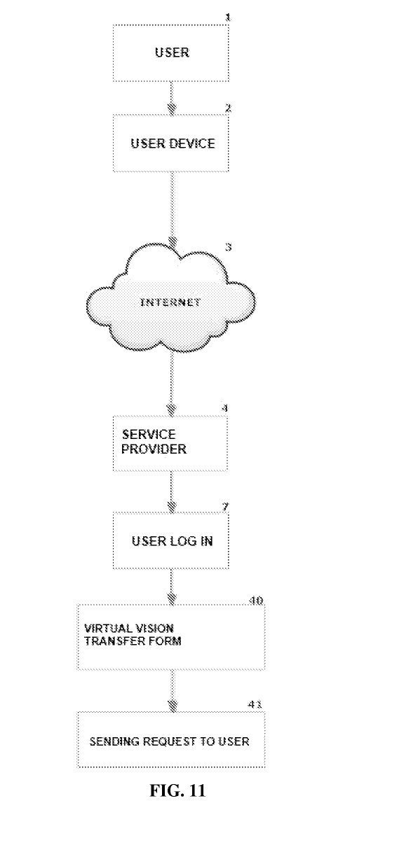

This invention also allows for transferring usage rights of a virtual vision 8 from a user account and for a certain period of time to another user account 7. In order to transfer a virtual vision 8 the creator 1, who is the owner of the virtual vision 8, should via the user device 2 connect to the network 3 (e.g. Internet) and initiate system log in 7 on the home page of the service provider 4. Then s/he needs to fill in a special form 40—FIG. 11 provided by the service provider 4 and allowing the creator to indicate his/her desire to transfer a virtual vision 8 of his and to specify the time and/or other conditionalities relating to the transfer. When the form 40 is filled, the system sends a request to user account 7 which the transfer from form 40 is made to.

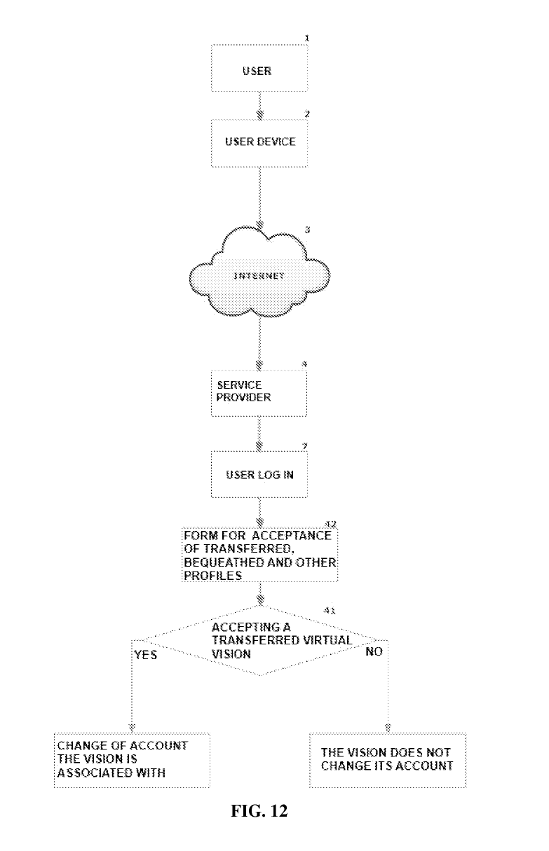

In order to finalize the transfer of a virtual vision 8 the creator 1 who is being transferred the usage rights for a limited period of time and/or under certain conditions should accept the transfer offer. Creator 1 who was offered a transfer using the user device 2 connected to the network 3, usually Internet, initiates system log in 7 on the home page of the service provider 4. Then s/he needs to access the special user form 42—FIG. 12 in which s/he can take action 43 of either accepting or rejecting the transfer. If creator 1 being transferred the virtual vision 8 accepts the offer, the system changes 44 account 7 which the respective virtual vision 8 is associated with. If creator 1 being transferred the virtual vision 8 rejects the offer, the system takes no action relating to changing the associated account 45.

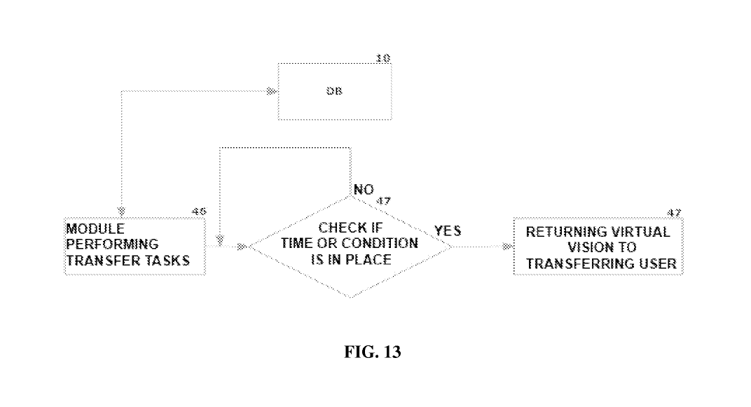

Since this invention allows for transfers which are limited in time and/or conditional, the system of the service provider should support a special module performing virtual visions transfer termination tasks 46—FIG. 13. This module retrieves information about the time limit or the transfer conditions specified in the transfer, as well as information about accounts 7 which the transfer functionality was used by from a special data base 10 of the service provider 4. Retrieving the necessary information module 46 runs checks 47 as to whether the transfer period has expired and/or the predefined conditions have been met. In the cases when the transfer period has expired and/or the predefined conditions have not been fulfilled the system initiates the return 47 of virtual visions 8 to the account 7 they were transferred from.

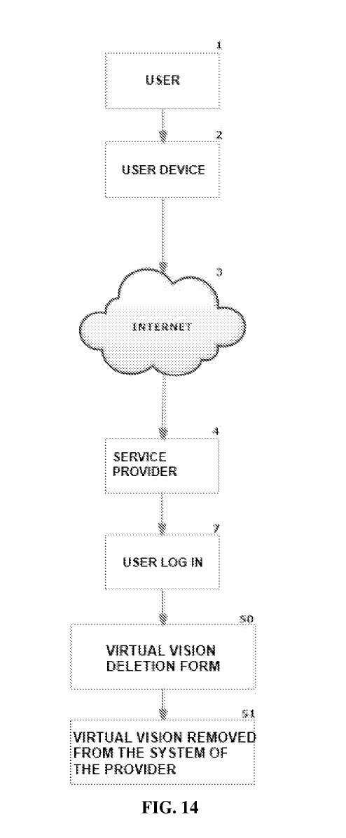

Several virtual visions 8 may be associated with one account in the network system for communication between creators 1 together with their transfer, sale, deletion from the system of the provider 4. Unlike the existing systems for communication between creators this invention allows for the deletion of virtual visions 8 without losing the user account 7. In order to delete a virtual vision 8 from the system of the provider 4 the creator 1 should use his/her user device 2 connected to the network 3. Accessing the home page of the provider 4 the creator 1 logs into the system 7 where he can use virtual visions 8 deletion form 50—FIG. 14. After form 50 is filled and the request sent to the system of the provider 4, the virtual vision 8 is deactivated and/or stops being accessible to all service users whereby the objectification of the virtual vision 8 is discontinued.

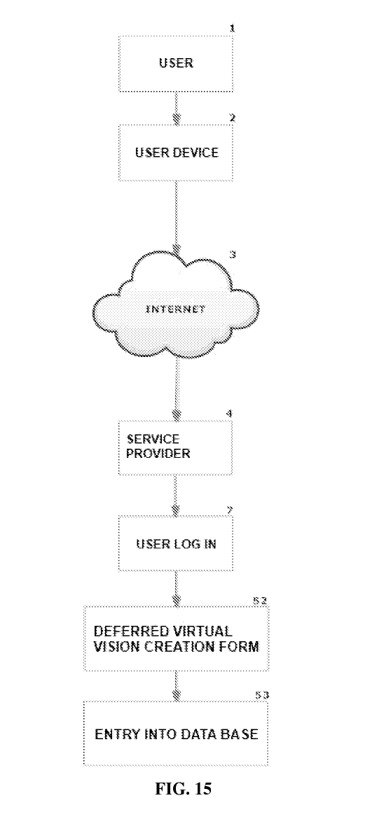

Given the specificity of the services provided by the providers 4 which allow for the creation of more than one virtual vision 8 to be used for communication with other creators 1, it is assumed that these virtual visions 8 may also contain concrete information. This is why this invention has an option for deferred objectification of virtual visions 8 in the services of the provider 4 providing that certain objectification conditions are fulfilled (e.g. objectification on a certain day and at a certain time). In order to use this functionality of the invention the creator 1 via the user device 2 connected to the network 3, usually Internet, initiates system log in 7 on the home page of the service provider 4. Then the creator 1 should use the special from 52 for deferred creation and objectification of virtual vision 8—FIG. 15. After the necessary data for deferred objectification as defined by the service provider 4 is entered, the system makes entry 53 in the data base 10.

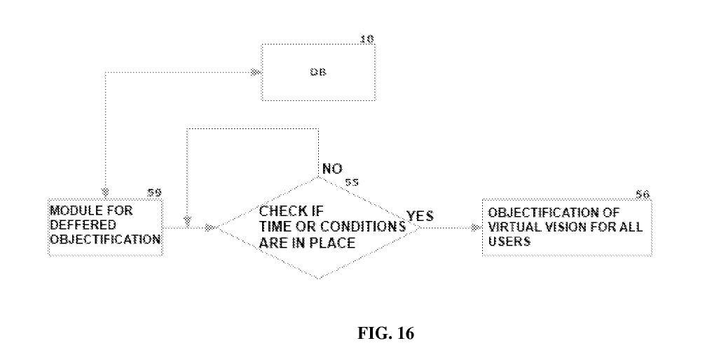

In order for the deferred objectification of a virtual vision 8 to take place, the system of the provider 4 supports a special module 54 performing virtual vision 8 objectification tasks—FIG. 16. This module 54 retrieves information from entries 53 in the data base 10 and runs checks 55 as to whether the conditions as predefined in form 52 for deferred objectification of virtual vision 8 have been met—FIG. 15. If the conditions have been fulfilled, the system objectifies 56 the virtual vision 8 for all creators 1.

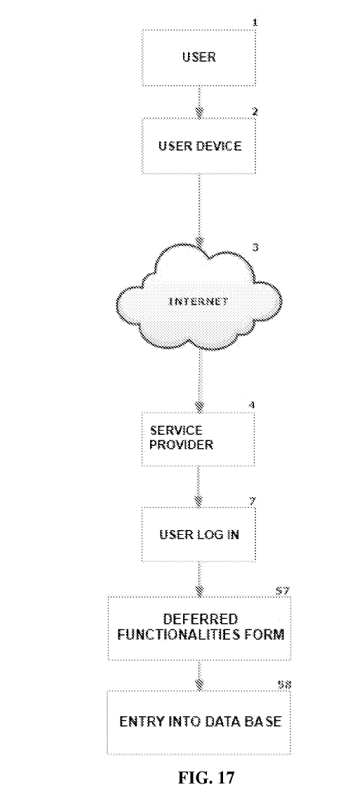

This invention allows for automatic deferred objectification of content or for automatic execution of certain functionalities of the system of the provider 4 via a concrete virtual vision of an account and provided that certain objectification conditions are fulfilled (e.g. objectification or execution of a given functionality on a certain day and at a certain time). In order to use this functionality of the invention the creator 1 via the user device 2 connected to the network 3, usually Internet, initiates system log in 7 on the home page of the service provider 4. Then s/he should use the special form 57 for automatic deferred objectification of content or automatic execution of certain functionalities—FIG. 17. After the data necessary for automatic deferred objectification of content or automatic execution of certain functionalities as predefined by the service provider 4 is entered, the system makes entry 58 in the data base 10.

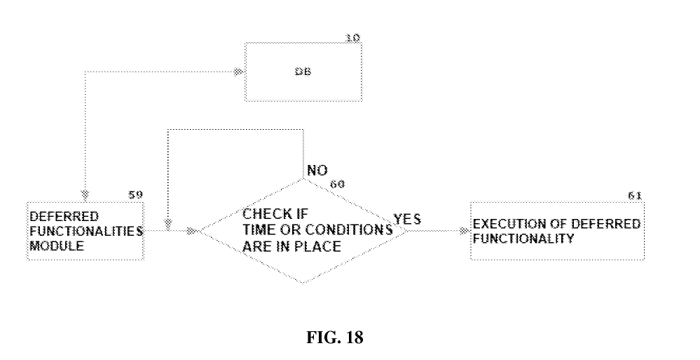

In order to perform automatic deferred objectification of content or automatic execution of certain functionalities the system of the provider 4 supports a special module 59 for automatic deferred objectification of content or automatic execution of certain functionalities—FIG. 18. This module 59 retrieves information from entries 58—FIG. 17 in the data base 10 and runs checks 60 as to whether the predefined conditions in form 57 for automatic deferred objectification of content or automatic execution of certain functionalities are met. If these conditions have been fulfilled, then the system performs the objectification or the execution of the functionalities specified in form 57 on behalf of the virtual vision 8.

These samples of the application of the invention are examples of regulated management of virtual visions, mostly in social or other networks designed to provide communication between creators. The invention however does not exclude the option of it being used in other types of software products such as games, blogs, content share networks as well as any other type of network software.

1. A method for regulated management of virtual visions which the users employ to communicate in a multilayered communicative fragmentation wherein the users (1), via user devices (2), connect to the computer network (3), e.g. Internet, create their own user account (5), and get access to the services (6) of the provider (4), wherein, the users (1) create one or more virtual visions (8), having multiple options to create virtual visions (8) associated with the user account (5), whereby by creating at least one virtual vision each user becomes a creator (1), the creation of a virtual vision (8) is recorded by way of entry (9) in the data base (10) provided by the service provider (4), upon creating the virtual vision/s (8) the creators (1) define the conditions of the objectification of a virtual vision (8) in the services of the provider (4); and the creators (1) are free to operate without limitations with their virtual visions (8), including to delete them.

2. The method according to claim 1, wherein a condition for objectification of a virtual vision (8) is a predefined moment in time or period of time.

3. The method according to claim 1, wherein a condition for objectification of a virtual vision (8) is a predefined condition and/or external information for the provider (4) which the service provider (4) deems useful for the creators (1).

4. The method according to claim 1, wherein the creator operates with the created virtual visions (8) by bequeathing them for which purpose after logging in the system the user (1) fills in an electronic will form (22) whereby s/he indicates the concrete terms of the will (23), and the filled form is entered into a data base (10) provided by the provider (4).

5. The method according to claim 1, wherein the creator (1) operates with the virtual visions (8) by leaving them as “memory” for which purpose the creator (1) connects using the user device (2) via the network (3) to the home page of the provider (4), logs in the account (7) of the system of the provider (4), following which the creator (1) fills in a special form (30) for leaving as “memory” and sends it to the provider (4), after which the system processes the request (31) and indicates to the other creators (1) that the respective virtual vision (8) was left as “memory”.

6. The method according to claim 1, wherein the creator (1) operates with his/her virtual visions (8) by selling them for which purpose the creator (1) connects via a user device (2) and a network (3) to the home page of the provider (4) and upon logging in the system of the provider (4) the user (1) fills in form (33) for offering for sale which is sent to the provider (4), then the system processes the request (34), indicates it to the other creators (1), and the candidate to purchase a given virtual vision (8) creator (1) via the user device (2) connected to the network (3) goes to the home page of the provider (4), reviews the section visualizing the virtual visions (8) offered for sale and sends a purchase request (7) following which the system sends a system request (36) to the creator-seller (1) of the virtual visions (8) who connects using his/her user devise (2) via the network (3) to the home page of the service provider (4), logs in (7) the system and after reviewing and assessing the offers, selects a specific offer (38) for the sale of a virtual vision (8), whereby the system provides the creator—buyer (1) with a way to pay for the virtual vision after which the payment is made and verified (39), the transaction is completed and the system transfers the purchased virtual vision (8) to the account of the creator—buyer (1).

7. The method according to claim 6, wherein the concrete offer (38) for purchasing a virtual vision takes the form of bidding.

8. The method according to claim 6, wherein the concrete offer (38) for acquiring a virtual vision (8) takes the form of virtual visions swap.

9. The method according to claim 1, wherein the creator (1) operates with his/her virtual visions (8) by transferring the rights of use to different user accounts (7) for which purpose the owner of the virtual vision (8) connects using a user device (2) via a network (3) and initiates system log in (7) on the home page of the service provider (4) and then s/he fills in a special form (40) provided by the service provider (4) indicating his/her desire to transfer a virtual vision (8) and specifying the time and/or other conditionalities relating to the transfer and after the form (40) is filled, the system sends a request to the user account (7) which the transfer is made to with the creator (1) who is being transferred the usage rights for a limited period of time and/or under certain conditions being able to accept or not the transfer offer for which purpose creator (1) who was offered a transfer using the user device (2) connected to the network (3) initiates system log in (7) on the home page of the service provider (4) and then fills in the special user form whereby s/he either accepts or rejects the transferred virtual vision (8) and if the creator (1) accepts the virtual vision (8), the system changes the account (7) which the respective virtual vision (8) is associated with and if creator (1) rejects the transferred virtual vision (8), the system takes no action relating to changing the associated account.

10. The method according to claim 9, wherein a given virtual vision (8) is transferred for a certain period of time and/or until the occurrence of specific, predefined circumstances for which purpose the system of the service provider (4) has a module for tasks relating to transfer termination which retrieves information about the timing and/or occurrence of the transfer conditions as well as information about the accounts (7) between which the functionality was used from the service provider (4) data base (10) and after retrieving the necessary information the transfer termination module performs checks as to whether the time and/or termination transfer conditions are in place and when the conditions are met, the system returns the virtual vision (8) to the account (7) it was transferred from.

11. The method according to claim 1, wherein the creator (1) freely operates with his/her virtual visions (8) by deleting them but without losing his/her user account (7) with in order to delete a virtual vision (8) from the service provider's system (4), the creator (1) via the user device (2) connected to the computer network (3) accesses the home page of the provider (4) and logs in (7) the system and fills in a virtual vision (8) deletion form (50) then the request is sent to the system of the service provider (4) whereby the virtual vision (8) is deactivated and/or stops being accessible to all the creators (1) which discontinues the objectification of the virtual vision (8).

12. The method according to claim 11, wherein the system allows for deferred objectification of a virtual vision (8) in the provider's services (4) subject to certain objectification conditions for which purpose the creator (1) using the user device (2) connected to the network (3) enters the home page of the service provider (4) and initiates log in (7), then fills in a deferred virtual vision (8) creation and objectification form, after which the system registers it in the data base (10) and in order to perform automatic deferred objectification of a virtual vision (8), the system of the provider (4) supports an automatic deferred objectification module (59) which module connects to and retrieves information from the data base (10) and performs checks as to whether the predefined automatic deferred objectification conditions entered into the form are met and if the conditions are met, the system performs objectification or executes the functionalities entered on behalf of the virtual vision (8).
